(19) United States
(12) Patent Application Publication
(10) Pub. No.: US 2011/0183804 A1
(43) Pub. Date: Jul. 28, 2011

(54) Axle Drive

(75) Inventor: Karsten FABIAN, Oberschleissheim (DE)

(73) Assignee: Bayerische Motoren Werke Aktiengesellschaft, Muenchen (DE)

(21) Appl. No.: 13/034,047

(22) Filed: Feb. 24, 2011

Related U.S. Application Data
(63) Continuation of application No. PCT/EP2009/006339, filed on Sep. 2, 2009.

(30) Foreign Application Priority Data
Oct. 15, 2008 (DE) 10 2008 051 699.6

(51) Int. Cl. F16H 48/06

(52) U.S. Cl. 475/220

(57) ABSTRACT

An axle drive, includes an axle drive housing, a differential gear cage, and a left and a right roller bearing, by which the differential gear cage is mounted in a rotatable manner in the axle drive housing. The differential gear cage has a left and a right bearing seat for the left or the right roller bearing. The left and the right bearing seat is formed in each case by a separate component, which is different from the differential gear cage.

### CROSS-REFERENCE TO RELATED APPLICATIONS

This application is a continuation of PCT International Application No. PCT/EP2009/006339, filed Sep. 2, 2009, which claims priority under 35 U.S.C. §119 from German Patent Application No. DE 10 2008 051 699.6, filed Oct. 15, 2008, the entire disclosures of which are herein expressly incorporated by reference.

### BACKGROUND AND SUMMARY OF THE INVENTION

The present invention relates to an axle drive having an axle drive housing and a differential gear cage mounted in a rotatable manner in the axle drive housing.

Axle drives have an axle drive housing, in which a differential gear housing, which is referred to hereinafter as the “differential gear cage,” is mounted in a rotatable manner by way of a left and a right roller bearing. In the case of the axle drives known from the prior art (see FIG. 1), the inner rings of the two roller bearings are usually press fit onto the differential gear cage. For the arrangement of the two roller bearings, a corresponding bearing seat has to be reserved on the left and the right side of the differential gear cage, a state that requires construction space. This “additional width” that is necessary for the arrangement of the two roller bearings makes it difficult to install the differential gear cage into the axle drive housing, and makes it necessary to have a relatively large access opening in the axle drive housing.

The object of the invention is to provide an axle drive, which exhibits a compact design and in which the differential gear cage can be mounted more easily than in the case of conventional axle drives.

This and other objects are achieved by an axle drive, comprising an axle drive housing, a differential gear cage, and a left and a right roller bearing, by which the differential gear cage is mounted in a rotatable manner in the axle drive housing. The differential gear cage has a left and a right bearing seat for the respective left or right roller bearing. The left and the right bearing seat is formed in each case by a separate component, which is different from the differential gear cage.

In accordance with the invention, an axle drive includes an axle drive housing and a differential gear cage, which can be mounted in a rotatable manner therein. The differential gear cage is mounted in the axle drive housing by means of a left and a right roller bearing. For this purpose a left and a right bearing seat for the left or the right roller bearing is provided “at” the differential gear cage.

Further, the left and the right bearing seat is formed in each case by a separate component that is different from the differential gear cage. Therefore, in contrast to conventional axle drives, the two bearing seats are not connected in a single piece and/or permanently and rigidly to the differential gear cage.

Instead, when the differential gear cage is installed in the axle drive housing, the differential gear cage is inserted into the axle drive housing, initially without the two bearing seats, and then moved into position. Following the “pre-positioning” of the differential gear cage, the two bearing seats can be “attached” to the differential gear cage. As a result, the access opening, required to insert the differential gear cage into the axle drive housing can be designed so as to be smaller than in the case of the conventional axle drive housings, or in the event that the size of the access opening is predetermined, the installation of the differential gear cage is simpler than in the case of conventional axle drive housings.

For the arrangement of the two bearing seats, the differential gear cage exhibits on its mutually opposite sides a recess, into which a “coupling section” of the left or right bearing seat is inserted. In a first variant of the invention, the recesses have the shape of an inner cone, which tapers in the direction of the center of the differential gear cage. The coupling sections of the components forming the two bearing seats are designed to be suitably complementary—that is, in this case they have the shape of an outer cone.

As an alternative, the recesses and the coupling sections of the components forming the two bearing seats are also designed in a circularly cylindrical manner, so that the two components forming the bearing seats can be pressed into the recesses.

In order to achieve a defined position of the two components forming the bearing seats in relation to the differential gear cage, the two bearing seats can have in each case a first stop face, and the differential gear cage can have on both sides a second stop face, which interacts with the assigned first stop face.

In a variant of the invention, the two roller bearings, by which the differential gear cage is mounted in the axle drive housing, are disposed with their inner ring on a suitably dimensioned outer periphery of the respective left or right bearing seat.

In an additional embodiment of the invention, the inner ring of the two roller bearings is formed directly by an assigned outer periphery of the respective left or right bearing seat. Therefore, in this embodiment the two bearing seats are an integral part of the respective roller bearing.

The roller bearings may be, for example, angular contact ball bearings or tapered roller bearings, which are arranged in an X layout.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 depicts a state of the art differential gear cage of an axle drive;

FIG. 2 depicts an embodiment according to the invention, wherein a part of the axle drive housing is shown; and

FIG. 3 depicts two different variants according to the invention.

### DETAILED DESCRIPTION OF THE DRAWINGS

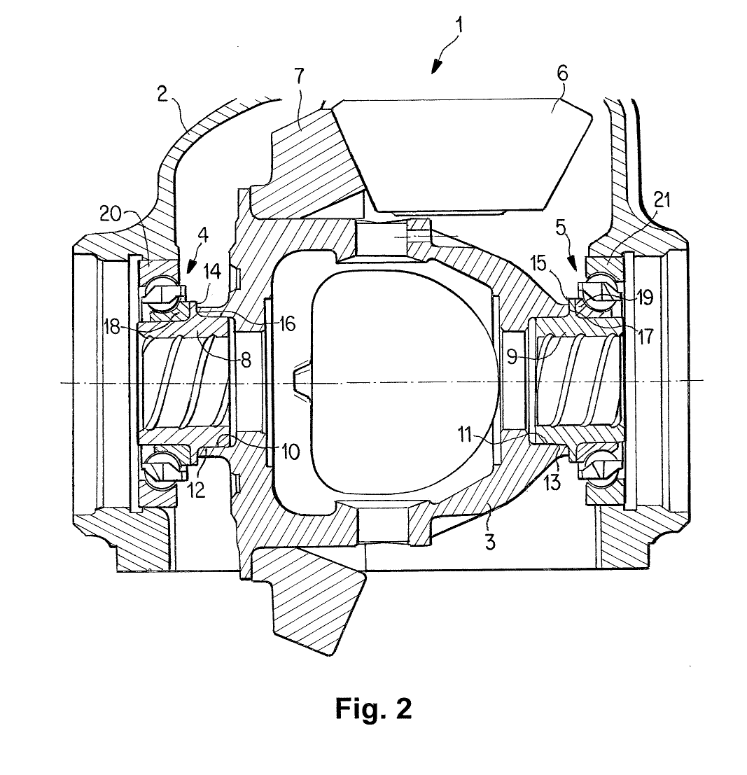

FIG. 2 shows an axle drive 1 having an axle drive housing 2, in which a differential gear cage 3 is mounted in a rotatable manner. Such details as the differential gears, which are disposed inside the differential gear cage 3, and the output shafts, are not illustrated.

The differential gear cage 3 is mounted in a rotatable manner in the axle drive housing 2 by way of a left angular contact ball bearing 4 and a right angular contact ball bearing 5, both of which are arranged in an X layout. A drive shaft drives the differential gear cage 3 by way of a bevel drive pinion 6 and a ring gear 7, which is connected rigidly to the differential gear cage 3.

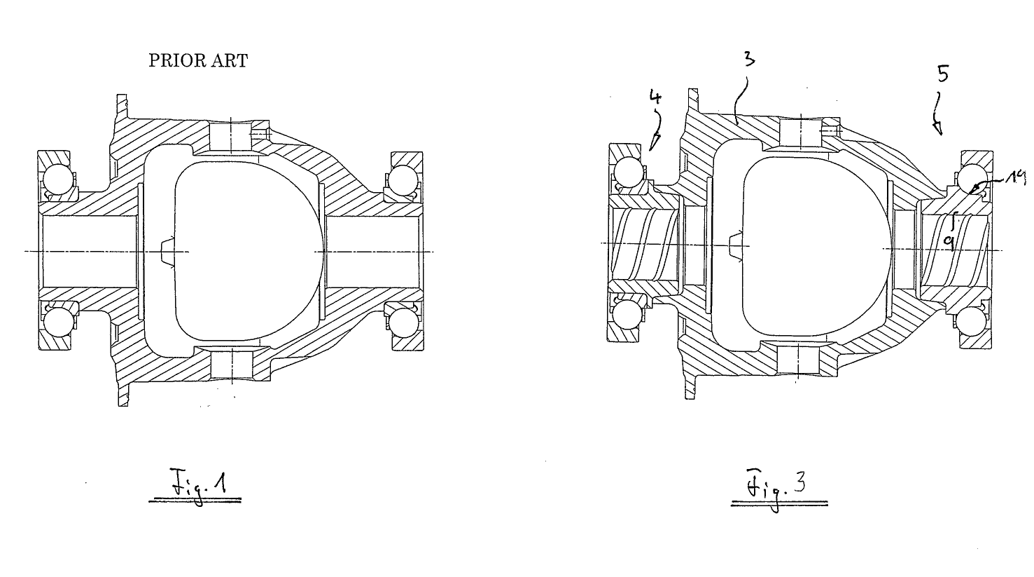

In contrast to the differential gear cage from the prior art that is shown in FIG. 1, the two roller bearings 4, 5 are not disposed directly on the differential gear cage 3. Rather, the bearing seats of the two roller bearings 4, 5 are formed by separate components 8, 9.

FIG. 2 shows that the differential gear cage 3 has on two mutually opposing sides recesses 10, 11, which are shaped in the manner of an inwardly directed cone and as such taper conically inward in the direction of the middle of the differential gear cage 3. To this end the components 8, 9, forming the two bearing seats, have outer cone sections 12, 13 that are designed so as to be complementary. In order to achieve a defined position of the bearing seats in relation to the differential gear cage 3, the two components 8, 9, forming the bearing seats, and the differential gear cage 3 have in each case first stop faces 14, 15 or second stop faces 16, 17 that rest against each other.

It is apparent from FIG. 2 that the inner rings or raceways 18, 19 of the two roller bearings 4, 5 are placed on the assigned outer peripheries of the components 8 or 9, forming the bearing seats. The outer rings or raceways 20, 21 of the two roller bearings 4, 5 are inserted into the assigned recesses of the axle drive housing 2.

It is clear from a comparison of the axle drive 1, shown in FIG. 2, with the conventional differential gear cage, shown in FIG. 1, that the differential gear cage 3 of the embodiment in FIG. 2 has a width that is significantly smaller than the differential gear cage shown in FIG. 1. Therefore, in the course of assembling the axle drive 1, the differential gear cage 3 can be inserted first into the axle drive housing 1 and pre-positioned. Then, in another step, the two components 8, 9, which form the bearing seats, can be mounted. Therefore, in order to insert the differential gear cage 3 into the axle drive housing 1, one can make do with an access opening that is smaller in size than the access opening that is required to insert the conventional differential gear cages. Owing to the more compact design of the differential gear cage 3, it can also be positioned with greater ease in the axle drive housing 2.

FIG. 3 shows a differential gear cage 3, in which the left roller bearing 4 is disposed in the same way as in the embodiment in FIG. 2. In the case of the right roller bearing 5, however, the “inner ring” or “inner raceway” 19 is formed directly by an assigned outer periphery of the component 9, forming the bearing seat. Thus, the component 9 is simultaneously an integral part of the angular contact ball bearing 5.

For the assembly of the axle drive, an access opening, which is closed by a housing cover, can be provided in the axle drive housing 2 on the side opposite the drive pinion 6. As an alternative, one of the two sides—that is, where the two roller bearings 4, 5 are disposed in the embodiment shown in FIG. 2—can also have a housing cover, which makes it possible to access the interior of the axle drive housing 2 and, thus, to mount the differential gear cage 3.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An axle drive, comprising
an axle drive housing;
a differential gear cage mounted rotatably in the axle drive housing;
a first separate component different from the differential gear cage carrying a first bearing seat for a first roller bearing at one end of the differential gear cage; and
a second separate component different from the differential gear cage carrying a second bearing seat for a second roller bearing for the other end of the differential gear cage, the differential gear cage being mounted rotatably in the axle drive housing via the first and second roller bearings.

2. The axle drive according to claim 1, wherein the differential gear cage has, on mutually opposite sides, a recess, into which a coupling section of the first or second separate components is inserted.

3. The axle drive according to claim 2, wherein each recess has a truncated cone shape tapering inwardly in a direction of a center of the differential gear cage; and
wherein the coupling section has a complementary truncated conical shape.

4. The axle drive according to claim 2, wherein the respective recesses and coupling sections are configured in a circularly cylindrical manner and form press fit couplings.

5. The axle drive according to claim 1, wherein the bearing seats each have a first stop face, and the differential gear cage has second stop faces interacting with the first stop faces; and
wherein the first stop face of the first and second bearing seats rests against a corresponding second stop face of the differential gear cage providing a defined press fit of the first and second bearing seats in the recesses of the differential gear cage.

6. The axle drive according to claim 1, wherein the first and second roller bearings having respective inner rings, the inner ring of the first or the second roller bearing being formed by an outer periphery of the respective first or second bearing seat.

7. The axle drive according to claim 1, wherein the first and second roller bearings have respective inner rings, the inner ring of the first and second roller bearing being disposed on an inner periphery of the respective first or second bearing seat.

8. The axle drive according to claim 1, wherein the first and second roller bearings are one of angular contact ball bearings and taper roller bearings, arranged in an X-layout configuration.

9. The axle drive according to claim 1, wherein the axle drive housing comprises an access opening closable by a housing cover, a pinion shaft acting as a drive shaft for the differential gear cage projecting into the axle drive housing; and
two output shafts arranged essentially perpendicular to the pinion shaft on mutually opposite sides of the axle drive housing extend through a respective bearing seat out of the differential gear cage.

10. The axle drive according to claim 9, wherein the housing cover is arranged on a side of the axle drive housing facing away from the pinion shaft.

11. The axle drive according to claim 9, wherein the housing cover is arranged on one of a left and right side of the axle drive housing, wherein one of the two output shafts extend through an opening provided in the housing cover out of the axle drive.

12. A rotatably mountable differential gear, comprising:
a differential gear cage;
a first roller bearing operatively arranged on one side of the differential gear cage;
a second roller bearing operatively arranged on an opposite side of the differential gear cage;
wherein each roller bearing comprises a bearing seat formed by a separate component different from the differential gear cage, the roller bearings being operatively configurable for rotatably mounting the differential gear cage in an axle drive housing.

13. The differential gear according to claim 12, further comprising recesses formed on mutually opposite sides of the differential gear cage, each recess being operatively configured to receive a coupling section of the separate component of the roller bearing.

14. The differential gear according to claim 13, wherein each recess has a truncated cone shape tapering inwardly in a direction of a center of the differential gear cage, the coupling sections having a complementary outer truncated cone shape.

15. The differential gear according to claim 14, wherein each separate component has a first stop face engaging with a corresponding second stop face of the differential gear cage, whereby a press fit is defined between the coupling section and the recess when the first stop face abuts against the second stop face.

16. The differential gear according to claim 9, wherein each roller bearing comprises an inner ring, the inner ring being disposed on an outer periphery of the separate component forming the bearing seat.
